(19) United States
(12) Patent Application Publication
(10) Pub. No.: US 2026/0356002 A1
(43) Pub. Date: Nov. 12, 2026

(54) A METHOD FOR MANUFACTURING A LAMINATE COMPRISING A STACK OF COMPOSITE FIBRE BOARDS

(71) Applicant: ECOR GLOBAL INC, La Jolla, CA (US)

(72) Inventors: Roberto REYES, Temecula, CA (US); Nemanja NIKOLIC, Kraljevo (RS); Dejan VUJOVIC, Kraljevo (RS); Branko BUGARCIC, Backa Palanka (RS)

(21) Appl. No.: 19/135,035

(22) PCT Filed: Nov. 21, 2023
(86) PCT No.: PCT/IB2023/061725

§ 371 Date: Jun. 2, 2025

(30) Foreign Application Priority Data
Dec. 6, 2022 (NL) 2033678

(51) Int. Cl. B27N 3/00; B27N 3/04; B32B 7/12; B32B 21/02

(52) U.S. Cl. CPC B27N 3/002; B27N 3/04; B32B 7/12; B32B 21/02; B32B 2307/72; B32B 2607/00

(57) ABSTRACT

The present invention relates to a method for manufacturing a laminate comprising a stack of composite fibre boards. The present invention also relates to such a laminate as well as to its use in interior and exterior applications chosen from the group of flooring, furniture, wall coverings, facades, and ceilings. An object of the present invention is providing a method for manufacturing a laminate comprising a stack of composite fibre boards as an alternative for wood-based products without the use of formaldehyde based adhesives.

The present invention relates to a method for manufacturing a laminate comprising a stack of composite fibre boards. The present invention also relates to such a laminate as well as to its use in interior and exterior applications.

European patent application EP 3 767 055 relates to a water impervious wall panel system comprising an intermediate first waterproof wall panel and an end second waterproof wall panel, wherein the intermediate first waterproof wall panel and the end second waterproof wall panel each comprise a core of wood plastics composite. The core is a wood plastics composite foamed board composed of PVC and wood fibre and the intermediate first waterproof wall panel and the end second waterproof wall panel each further comprise a laminate adhesively attached to the core, wherein the laminate is a high pressure laminate, and the adhesive is a polyurethane adhesive.

US 2019/308392 relates to a process for manufacturing a composite board comprising mixing bast fibers and/or glass fibers with plastic fibers thereby forming a fiber layer, and thermoforming said fiber layer into a nonwoven composite material layer, wherein said thermoforming comprises impregnating the fiber layer under vacuum conditions with liquid thermoset and heating.

US 2017/320309 relates to a method of making a composite panel configured for use with a flooring assembly of a trailer, the method comprising: providing a wood substrate, making an uncured fiber-reinforced coating, applying the uncured fiber-reinforced coating onto a surface of the wood substrate to form a composite assembly; and curing the uncured composite assembly, thereby coupling a cured fiber-reinforced coating to the wood substrate, wherein making the fiber-reinforced coating further comprises the step of applying constant pressure of between 1 and 2.4 bar to the composite assembly.

WO 2012/009514 relates to a method for forming a biolaminate structure, the method comprising providing a first paper layer, providing a biobased polymer film layer, providing a second paper layer, and at least partially saturating the first paper layer and the second paper layer with a biobased polymer, wherein saturation may be from the biobased polymer of the biobased polymer film layer or may be from an additional biobased polymer source, fusing the first paper layer, the biobased polymer film layer, and the second paper layer under means of heat and pressure to form the biolaminate structure, wherein fusing is done at a pressure between about 1.4 bar and about 103.4 bar and temperatures range from 154 °C to 204 °C

US 2015/151449 relates to a method for producing a lignocellulosic composite, the method comprising providing an aqueous adhesive material comprising a magnesium oxychloride compound and a proteinaceous material, applying the aqueous adhesive material to a lignocellulosic substrate, curing the aqueous adhesive material, wherein curing the aqueous adhesive material comprises applying pressure of between about 0.7 bar and 69 bar at a temperature of between about 50 °C and 250 °C.

WO 99/66119 relates to a method of manufacturing an Arundo donax composite panel, the method comprising comminuting Arundo donax into particles of a size distribution suitable for use as furnish in a composite panel, mixing the particles with a binder to provide a binder-particle mixture, and consolidating the binder-particle mixture into a composite panel. When MDI resin is used, the press is typically operated at a temperature in the range of 160-170 °C, and under pressure of between 34.5-41.4 bar (maximum) during the closing cycle and about 7 bar during the curing cycle.

KR 2013 0102981 relates to a manufacturing method for composite flooring board comprising a first single board, a flat material, and a second single board, wherein the compression method is performed by cold pressure and hot pressure, wherein the cold pressure is compressed for 10 to 60 minutes at a pressure of 5 to 15 kgf/cm², and the hot pressure is compressed for 10 to 60 minutes at a pressure of 5 to 15 kgf/cm² at a temperature of 100 to 200 °C.

Laminates for interior and exterior applications must meet specific requirements. For example, the laminate as such must not delaminate. In addition, the laminate must be dimensional stable.

The object of the present invention is to provide a method for manufacturing a laminate comprising a stack of composite fibre boards, wherein the laminate thus obtained does not delaminate.

An object of the present invention is providing a method for manufacturing a laminate comprising a stack of composite fibre boards as an alternative for wood-based products without the use of formaldehyde based adhesives.

Another object of the present invention is to provide a method for manufacturing a laminate comprising a stack of composite fibre boards wherein a plurality of its components are natural based components and/or recycled components.

Another object of the present invention is to provide a laminate comprising a stack of composite fibre boards that has a high dimensional level of stability and flatness.

The present invention relates to a method for manufacturing a laminate comprising a stack of composite fibre boards, the method comprising the steps of:
i) providing composite fibre boards based on agricultural materials,
ii) creating a stack of composite fibre boards of i), wherein an adhesive is applied between the individual composite fibre boards of the stack,
iii) applying lamination conditions on the stack of ii) for obtaining the laminate.

The present inventors found that one or more of the above objects can be achieved by providing a specific process for manufacturing the laminate. The present inventors were able to provide method for manufacturing a laminate comprising a stack of composite fibre boards wherein the mixture of raw materials is recyclable, biobased, sustainable, environmentally friendly and/or biodegradable.

According to the method for manufacturing a laminate comprising a stack of composite fibre boards, the lamination conditions comprise a temperature in a range of 75-85 °C, a duration in a range of 240-300 s and a pressure in a range of 6-14 kg/cm². In a situation wherein process conditions outside the aforementioned process window of temperature, time and pressure are applied, a laminate is obtained that may suffer from delamination, warping and/or tearing.

According to the method for manufacturing a laminate comprising a stack of composite fibre boards, the amount of adhesive is in a range of 150-160 g/m². If the amount of adhesive is lower than 150 g/m² delamination issues may occur. If the amount of adhesive is above 160 g/m² no beneficial effects will be observed.

In an example the adhesive is a polyvinyl acetate based adhesive, preferably a polyvinyl acetate based adhesive class D4 according to European standard BS EN 204. The D grading stands for durability and are part of the European standard BS EN 204 governing the classification of wood glues for non-structural applications. The D4 grade refers to interior areas with frequent long-term exposure to running or condensed water. Exterior areas exposed to weather. D4 adhesives have a seven-day shelf life with a required bond strength of more than 10N/mm².

In an example the laminate comprising a stack of composite fibre boards is free of any formaldehyde or formaldehyde derivatives.

In an example of the method for manufacturing a laminate comprising a stack of composite fibre boards the method further comprises a step of applying one or more finishing layers, optionally including a pre-printing layer and/or a printed décor layer, on one or more sides of the stack of composite fibre boards. Examples of such finishing layers are paintings or coatings, waterborne or UV, digital printing and decorative layers. These surface techniques have design and/or protection functions.

The present invention also relates to a laminate obtained according to a method as discussed above and having a thickness of 0.5-50 mm, a density of 300-1100 kg/m³ and such a laminate must meet the requirements of a test method JAS type 2 and of test method ANSI as described in the present description.

The present invention also relates to a method for manufacturing a composite fibre board as mentioned above, the method comprising the steps of:
a) providing a mixture of raw materials comprising fibres,
b) thermopressing the mixture of a) in a temperature range of 120 °C to 210 °C, a pressure in a range from 3 to 200 kg/cm² and a reaction time from 1 to 20 minutes,

wherein the raw material mixture comprises 0-35 wt. % silicone coated paper and 65-100 wt. % agricultural materials, based on the total weight of the raw material mixture.

In an example, the agricultural materials are chosen from the group of wheat straw, corn straw or silage, rice straw, cotton, hemp, kenaf, sugarcane bagasse, bamboo, soya straw, miscanthus, rapeseed straw, sunflower straw, agave, and other fibres resulting from underutilized or waste streams as a result of agri-business or manufacturing processes, such as coffee grounds, nut shells, husks, and eggshells, or a combination thereof.

In an example, the raw material mixture further comprises 1-35 wt. % natural paper based cellulose fibres chosen from the group of recycled cardboard, recycled craft or kraft paper, recycled office paper, and recycled newsprint, or a combination thereof, based on the total weight of the raw material mixture.

The composite fibre board obtained according to a method as discussed above has a thickness of 0.5-50 mm and a density of 300-1100 kg/m³.

The present invention also relates to the interior and/or exterior use of a laminate as discussed above as a construction material chosen from the group of flooring, furniture, wall coverings, facades, and ceilings. The present laminate may contain additional components, such as flame retardants, plasticizers, pigments, dyes, fillers, emulsifiers, surfactants, thickeners, rheology modifiers, heat, and radiation stabilization additives, defoamers, levelling agents, anti-cratering agents, fillers, sedimentation inhibitors, U.V. absorbers, and antioxidants.

The present invention also relates to flooring, furniture, wall coverings, facades, and ceilings comprising a laminate as discussed above.

In order to further understand the techniques, means and effects of the present disclosure, the following detailed descriptions and examples are hereby referred to, such that, and through which, the purposes, features and aspects of the present disclosure can be thoroughly and concretely appreciated; however, the appended examples are merely provided for reference and illustration, without any intention to be used for limiting the present disclosure.

In the experimental section two specific tests were used, namely ANSI test and JAS test type 2.

ANSI test (American National Standard for Laminated Hard Wood Flooring) The test is conducted on a real flooring 50.8 mm×127 mm. The following test procedure is applied: water soaking 24±3 °C 4 hrs, dry oven 49-52 °C 19 h. (dry content max 8%) and repeat until failure/rupture or at least 3 cycles.

Failure: delamination between two layers exceeding a length of 50.8 mm, depth of 6.4 mm and thickness of 0.08 mm.
95% of samples must manage 1 cycle
85% of samples must manage 3 cycles.

JAS test type 2

The JAS test type 2 (Japanese Agricultural Standard) includes: sampling:

The test is conducted on a real flooring 4 pieces, 75 mm*75 mm. The following test procedure is applied: water soaking 70±3 °C 2 hrs, dry oven 60±3 °C 3 rs and weighing before/after: max±5% of original weight. Judgement: delaminated glue-joint (max ⅓ or 33%).

The following experiments #1-#14 were conducted.

For experiments #1, #2, #5, #6, #9, #10, #11, #12 ECOR MDF 2.5 mm was used. The ECOR MDF 2.5 mm composition was as follows. A mixture of raw materials was prepared. The mixture comprising 40 wt. % soya, 30 wt. % wheat, 10 wt. % rapeseed, 10 wt. % hemp and 10 wt. % SCP. The mixture was milled, and the raw materials size was ≤1.2 mm. Raw material is mixed in water and at the stage of forming (before pressing) fibreboard “carpet” consists of 50% of solid content (raw material) and of 50% of moisture. The total solid content of the mixture before pressing was 50%. The process conditions for manufacturing a composite fibre board were: T=200 °C; P=7 kg/cm²; t=410 s.

For experiments #3, #4, #7, #8, #13, #14 ECOR HDF 2 mm was used. The ECOR HDF 2 mm composition was as follows. A mixture of raw materials was prepared. The mixture comprising 40 wt. % soya, 30 wt. % wheat, 10 wt. % rapeseed, 10 wt. % hemp and 10 wt. % SCP. The mixture was milled, and the raw materials size was ≤1.2 mm. Raw material is mixed in water and at the stage of forming (before pressing) fibreboard “carpet” consists of 50% of solid content (raw material) and of 50% of moisture. The total solid content of the mixture before pressing was 50%. The process conditions for manufacturing a composite fibre board were: T=200 °C; P=14 kg/cm²; t=355 s.

In standard EN 316—“Wood fibre boards—Definition, classification and symbols” a definition of wet and dry process board is provided. According to 2.2 the definition of wet process board refers to a fibreboard having a fibre moisture content of more than 20% at the stage of forming. According to 2.3 the definition of dry process board refers to a fibreboard having a fibre moisture content of less than 20% at the stage of forming.

Laminated ECOR MDF 10 mm samples produced in experiment #1 were used in experiment #2. Laminated ECOR MDF 10 mm samples produced in experiment #5 were used in experiment #6. Laminated ECOR MDF 10 mm samples produced in experiment #9 were used in experiment #10. Laminated ECOR MDF 10 mm samples produced in experiment #11 were used in experiment #12. Laminated ECOR HDF 10 mm samples produced in experiment #3 were used in experiment #4. Laminated ECOR HDF 10 mm samples produced in experiment #7 were used in experiment #8. Laminated ECOR HDF 10 mm samples produced in experiment #13 were used in experiment #14.

### Experiment 1

### Laminated MDF 10 mm

Panel Type: MDF 2.5 mm thickness (727 kg/m³), panel construction: 4 layers lamination, type of adhesive: polyvinyl acetate (Vinavil 2256 L).

Lamination Press parameters: T=80 °C; P=7 kg/cm²; t=300 s applied adhesive: 150 gr/m²;

Manufactured board characteristics: thickness—10 mm, density: 727 kg/m³

ANSI test: 1 cycle—100% samples passed (20 of 20 samples passed)
2cycle—100% samples passed (20 of 20 samples passed)
3cycle—95% samples passed (19 of 20 samples passed)−(necessary minimum 85% passed samples)

JAS test type 2: 95% samples passed (19 of 20 samples passed)−(necessary minimum 67% passed samples)

### Experiment 2

### Flooring Construction—Middle Layer Laminated MDF 10 mm

Sample construction: 3 layers lamination: Top layer—Oak—3 mm thickness, Middle layer—Laminated MDF 10 mm thickness Bottom layer—veneer 2 mm thickness), type of adhesive: polyvinyl acetate (Vinavil 2256 L)

Lamination Press parameters: T=80 °C; P=6 kg/cm²; t=300 s; applied adhesive: 150 g/m²;

Manufactured board characteristics: thickness—15 mm,

ANSI test: 1 cycle—100% samples passed (20 of 20 samples passed)
2 cycle—100% samples passed (20 of 20 samples passed)
3 cycle—90% samples passed (18 of 20 samples passed)—(necessary minimum 85% passed samples)

JAS test type 2: 85% samples passed (17 of 20 samples passed)—(necessary minimum 67% passed samples)

### Experiment 3

### Laminated HDF 10 mm

Panel Type: HDF 2 mm thickness (882 kg/m³), Panel construction: 5 layers lamination, Type of adhesive: polyvinyl acetate (Vinavil 2256 L)

Lamination Press parameters: T=80 °C; P=14 kg/cm²; t=240 s; applied adhesive: 150 g/m²

Manufactured board characteristics: thickness—10 mm, density: 882 kg/m³

ANSI test: 1 cycle—100% samples passed (20 of 20 samples passed)
2 cycle—100% samples passed (20 of 20 samples passed)
3 cycle—100% samples passed (20 of 20 samples passed)−(Necessary minimum 85% passed samples)

JAS test type 2: 95% samples passed (19 of 20 samples passed)−(necessary minimum 67% passed samples)

### Experiment 4

### Flooring Construction—Middle Layer Laminated HDF 10 mm

Sample construction: 3 layers lamination: Top layer—Oak—3 mm thickness, Middle layer—Laminated HDF 10 mm thickness, Bottom layer—veneer 2 mm thickness, type of adhesive: polyvinyl acetate (Vinavil 2256 L)

Lamination Press parameters: T=80 °C; P=6 kg/cm²; t=240 s; applied adhesive: 150g/m²;

Manufactured board characteristics: thickness—15 mm,

ANSI test: 1 cycle—100% samples passed (20 of 20 samples passed)
2 cycle—95% samples passed (19 of 20 samples passed)
3 cycle—95% samples passed (19 of 20 samples passed)−(Necessary minimum 85% passed samples)

JAS test type 2: 90% samples passed (18 of 20 samples passed)−(necessary minimum 67% passed samples)

### Experiment 5

### Laminated MDF 10 mm

Panel Type: MDF 2.5 mm thickness (742 kg/m³), panel construction: 4 layers lamination, type of adhesive: polyvinyl acetate (Kleiberit 314.3).

Lamination Press parameters: T=80 °C; P=7 kg/cm 2; t=270 s applied adhesive: g/m²;

Manufactured board characteristics: thickness—10 mm, density: 742 kg/m³

ANSI test: 1 cycle—100% samples passed (20 of 20 samples passed)
2 cycle—100% samples passed (20 of 20 samples passed)
3 cycle—100% samples passed (20 of 20 samples passed)−(necessary minimum 85% passed samples)

JAS test type 2: 95% samples passed (19 of 20 samples passed)−(necessary minimum 67% passed samples)

### Experiment 6

Flooring Construction—Middle Layer Laminated MDF 10 mm), sample construction: 3 layers lamination, top layer—Oak—3 mm thickness, middle layer laminated MDF 10 mm thickness, bottom layer—veneer 2 mm thickness, type of adhesive: polyvinyl acetate (Kleiberit 314.3)

Lamination Press parameters: T=80 °C; P=6 kg/cm²; t=270 s; applied adhesive: 160 g/m²;

Manufactured board characteristics: thickness—15 mm,

ANSI test: 1 cycle—100% samples passed (20 of 20 samples passed)
2 cycle—100% samples passed (20 of 20 samples passed)
3 cycle—95% samples passed (19 of 20 samples passed)

JAS test type 2: 90% samples passed (18 of 20 samples passed)−(necessary minimum 67% passed samples)

### Experiment 7

### Laminated HDF 10 mm

Panel Type: HDF 2 mm thickness (896 kg/m³) , panel construction: 5 layers lamination, type of adhesive: polyvinyl acetate (Kleiberit 314.3).

Lamination Press parameters: T=80 °C; P=14 kg/cm²; t=240 s; applied adhesive: 160 g/m²

Manufactured board characteristics: thickness—10 mm, density: 896 kg/m³

ANSI test: 1 cycle—100% samples passed (20 of 20 samples passed)
2 cycle—100% samples passed (20 of 20 samples passed)
3 cycle—100% samples passed (20 of 20 samples passed) )−(necessary minimum 85% passed samples)

JAS test type 2: 95% samples passed (19 of 20 samples passed)−(necessary minimum 67% passed samples)

### Experiment 8

(Flooring construction—middle layer Laminated HDF 10 mm), Sample construction: 3 layers lamination: top layer—Oak—3 mm thickness, middle layer—laminated HDF 10 mm thickness, bottom layer—veneer 2 mm thickness, type of adhesive: polyvinyl acetate (Kleiberit 314.3)

Lamination Press parameters: T=80 °C; P=6 kg/cm²; t=240 s; applied adhesive: 160 g/m²;

Manufactured board characteristics: thickness—15 mm,

ANSI test: 1 cycle—100% samples passed (20 of 20 samples passed)
2 cycle—100% samples passed (20 of 20 samples passed)
3 cycle—95% samples passed (19 of 20 samples passed)−(necessary minimum 85% passed samples)

JAS test type 2: 90% samples passed (18 of 20 samples passed) )−(necessary minimum 67% passed samples) .

Experiments 9-14 are not according to the invention because they did not pass the ANSI and/or JAS test type 2 as discussed above.

### Experiment 9 (Comparative Example)

### Laminated MDF 10 mm

Panel Type: MDF 2.5 mm thickness (714 kg/m³), panel construction: 4 layers lamination, type of adhesive: polyvinyl acetate (Vinavil 2256 L)

Lamination Press parameters: T=80 °C; P=7 kg/cm²; t=180 s; applied adhesive: 150g/m²;

Manufactured board characteristics: thickness—10 mm, density: 714 kg/m³

ANSI test: 1 cycle—100% samples passed (20 of 20 samples passed)
2 cycle—95% samples passed (19 of 20 samples passed)
3 cycle—80% samples passed (16 of 20 samples passed)−(necessary minimum 85% passed samples)

JAS test type 2: 40% samples passed (8 of 20 samples passed)−(necessary minimum 67% passed samples)

### Experiment 10 (Comparative Example)

### Flooring Construction—Middle Layer Laminated MDF 10 mm

Sample construction: 3 layers lamination, top layer—Oak—3 mm thickness, middle layer—laminated MDF 10 mm thickness, bottom layer—veneer 2 mm thickness, type of adhesive: polyvinyl acetate (Vinavil 2256 L)

Lamination Press parameters: T=80 °C; P=6 kg/cm²; t=180 s; applied adhesive: 150 g/m²;

Manufactured board characteristics: thickness—15 mm,

ANSI test: 1 cycle—95% samples passed (19 of 20 samples passed)
2 cycle—85% samples passed (17 of 20 samples passed)
3 cycle—65% samples passed (13 of 20 samples passed)−(necessary minimum 85% passed samples)

JAS test type 2: 30% samples passed (6 of 20 samples passed)−(necessary minimum 67% passed samples)

### Experiment 11 (Comparative Example)

### Laminated MDF 10 mm

Panel Type: MDF 2.5 mm thickness (734 kg/m³, panel construction: 4 layers lamination, type of adhesive: polyvinyl acetate (Kleiberit 314.3)

Lamination Press parameters: T=80 °C; P=7 kg/cm²; t=270 s; applied adhesive: 130 g/m²;

Manufactured board characteristics: thickness—10 mm, density: 734 kg/m³

ANSI test: 1 cycle—90% samples passed (18 of 20 samples passed)
2 cycle—85% samples passed (17 of 20 samples passed)
3 cycle—80% samples passed (16 of 20 samples passed)−(necessary minimum 85% passed samples)

JAS test type 2: 35% samples passed (7 of 20 samples passed))−(necessary minimum 67% passed samples)

### Experiment 12 (Comparative Example)

### Flooring Construction—Middle Layer Laminated MDF 10 mm

Sample construction: 3 layers lamination, top layer—Oak—3 mm thickness, middle layer—laminated MDF 10 mm thickness, bottom layer—veneer 2 mm thickness, type of adhesive: polyvinyl acetate (Kleiberit 314.3)

Lamination Press parameters: T=80 °C; P=6 kg/cm²; t=270 s; applied adhesive: g/m²;

Manufactured board characteristics: thickness—15 mm,

ANSI test: 1 cycle—90% samples passed (18 of 20 samples passed)
2 cycle—75% samples passed (15 of 20 samples passed)
3 cycle—55% samples passed (11 of 20 samples passed)−(necessary minimum 85% passed samples)

JAS test type 2: 20% samples passed (4 of 20 samples passed) )−(necessary minimum 67% passed samples)

### Experiment 13 (Comparative Example)

### Laminated HDF 10 mm

Panel Type: HDF 2 mm thickness (903 kg/m³), panel construction: 5 layers lamination, type of adhesive: polyvinyl acetate (Vinavil 2256 L)

Lamination Press parameters: T=90 °C; P=14 kg/cm²; t=240 s; applied adhesive: 160 g/m²;

Manufactured board characteristics: thickness—10 mm, density: 903 kg/m³

ANSI test: 1 cycle—100% samples passed (20 of 20 samples passed)
2 cycle—90% samples passed (18 of 20 samples passed)
3 cycle—80% samples passed (16 of 20 samples passed)−(necessary minimum 85% passed samples)

JAS test type 2: 50% samples passed (10 of 20 samples passed)−(necessary minimum 67% passed samples)

### Experiment 14 (Comparative Example)

### Flooring Construction—Middle Layer Laminated HDF 10 mm

Sample construction: 3 layers lamination, top layer—Oak—3 mm thickness, middle layer—laminated HDF 10 mm thickness, bottom layer—veneer 2 mm thickness, type of adhesive: polyvinyl acetate (Vinavil 2256 L)

Lamination Press parameters: T=90 °C; P=6 kg/cm²; t=240 s; applied adhesive: 160 g/m²;

Manufactured board characteristics: thickness—15 mm,

ANSI test: 1 cycle—95% samples passed (19 of 20 samples passed)
2 cycle—85% samples passed (17 of 20 samples passed)
3 cycle—65% samples passed (13 of 20 samples passed)−(necessary minimum 85% passed samples)

JAS test type 2: 40% samples passed (8 of 20 samples passed)−(necessary minimum 67% passed samples)

1. A method for manufacturing a laminate comprising a stack of composite fibre boards, the method comprising the steps of:
providing composite fibre boards based on agricultural materials,
creating a stack of composite fibre boards of i), wherein an adhesive is applied between the individual composite fibre boards of the stack, and
applying lamination conditions on the stack of ii) for obtaining the laminate, wherein the lamination conditions comprise a temperature in a range of 75-85 °C, a duration in a range of 240-300 s and a pressure in a range of 6-14 kg/cm² and the amount of adhesive is in a range of 150-160 g/m².

2. A method according to claim 1, wherein the adhesive is a polyvinyl acetate based adhesive.

3. A method according to claim 2, wherein the adhesive is a polyvinyl acetate based adhesive class D4 according to European standard BS EN 204.

4. A method according to claim 1, wherein the laminate comprising a stack of composite fibre boards is free of any formaldehyde or formaldehyde derivatives.

5. A method according to claim 1, further comprising a step of applying one or more finishing layers, optionally including a pre-printing layer and/or a printed décor layer, on one or more sides of the stack of composite fibre boards.

6. A laminate obtained according to a method according to claim 1 having a thickness of 0.5-50 mm, a density of 300-1100 kg/m³, wherein said laminate meets the requirements of test method JAS type 2 and the requirements of test method ANSI as described in the description.

7. A method according to claim 1, wherein the composite fibre boards of i) are obtained according to a method for manufacturing a composite fibre board, the method comprising the steps of:
a) providing a mixture of raw materials comprising fibres,
b) thermopressing the mixture of a) in a temperature range of 120 °C to 210 °C, a pressure in a range from 3 to 200 kg/cm² and a reaction time from 1 to 20 minutes,
wherein the raw material mixture comprises 0-35 wt. % silicone coated paper and 65-100 wt. % agricultural materials, based on the total weight of the raw material mixture.

8. A method according to claim 7, wherein the agricultural materials are chosen from the group of wheat straw, corn straw or silage, rice straw, cotton, hemp, kenaf, sugarcane bagasse, bamboo, soya straw, miscanthus, rapeseed straw, sunflower straw, agave, and other fibres resulting from underutilized or waste streams as a result of agri-business or manufacturing processes, such as coffee grounds, nut shells, husks, and eggshells, or a combination thereof.

9. A method according to claim 7, wherein the raw material mixture further comprises 1-35 wt. % natural paper based cellulose fibres chosen from the group of recycled cardboard, recycled craft or kraft paper, recycled office paper, and recycled newsprint, or a combination thereof, based on the total weight of the raw material mixture.

10. A composite fibre board obtained according to a method according to claim 7 having a thickness of 0.5-50 mm and a density of 300-1100 kg/m3.

11. The interior and exterior use of a laminate obtained according to claim 1 or a laminate according to claim 6 as a construction material chosen from the group of flooring, furniture, wall coverings, facades, and ceilings.

12. Flooring, furniture, wall coverings, facades, and ceilings comprising a laminate obtained according to claim 1 or a laminate according to claim 6.
